(19) United States
(12) Patent Application Publication
(10) Pub. No.: US 2012/0188148 A1
(43) Pub. Date: Jul. 26, 2012

(54) Head Mounted Meta-Display System

(75) Inventor: Christian Dean DeJong, Sammamish, WA (US)

(73) Assignee: MICROVISION, INC., Redmond, WA (US)

(21) Appl. No.: 13/012,470

(22) Filed: Jan. 24, 2011

(51) Int. Cl. G09G 5/00; G02B 27/01

(52) U.S. Cl. 345/8; 359/630

(57) ABSTRACT

Briefly, in accordance with one or more embodiments, to implement a meta-display in a head or body worn display system, a display having a first field of view is stored in a memory, and a portion of the first field of view is displayed in a second field of view wherein the first field of view is larger than the second field of view. A position of a user's body is detected with a body sensor and a position of the user's head is detected with a head sensor. The portion of the first field of view displayed in the second field of view is based on a position of the user's head with respect to the user's body.

### BACKGROUND

In virtual reality type display systems, content that is stored at particular locations in the virtual reality display may be accessed via movements of the user's head or body. Generally, movement data is referenced to a real world, fixed reference. However such systems do not detect relative movements of one body part with respect to another body part. As a result, such systems are incapable of complex control and access to the contents of the display in a natural or selected manner such as moving a smaller field of view in the display with respect to a larger field of view of the display.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a block diagram of a display system that includes head and body sensors in accordance with one or more embodiments will be discussed;

FIG. 2 is a diagram of a head mounted display system incorporating the display system 100 of FIG. 1 in accordance with one or more embodiments;

FIG. 3 is a diagram of a meta-display capable of being displayed by the display system of FIG. 1 in accordance with one or more embodiments;

FIGS. 4A and 4B are diagrams of how a body sensor of the display system of FIG. 1 is capable of detecting a position of the body of a user in accordance with one or more embodiments;

FIGS. 5A and 5B are diagrams of how a head sensor is capable of detecting a position of the head of a user with respect to a position of the body of the user in accordance with one or more embodiments;

FIG. 6 is a diagram of a photonics of module comprising a scanned beam display of the display system of FIG. 1 in accordance with one or more embodiments; and

FIG. 7 is a diagram of an information handling system capable of operating with the display system of FIG. 1 in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

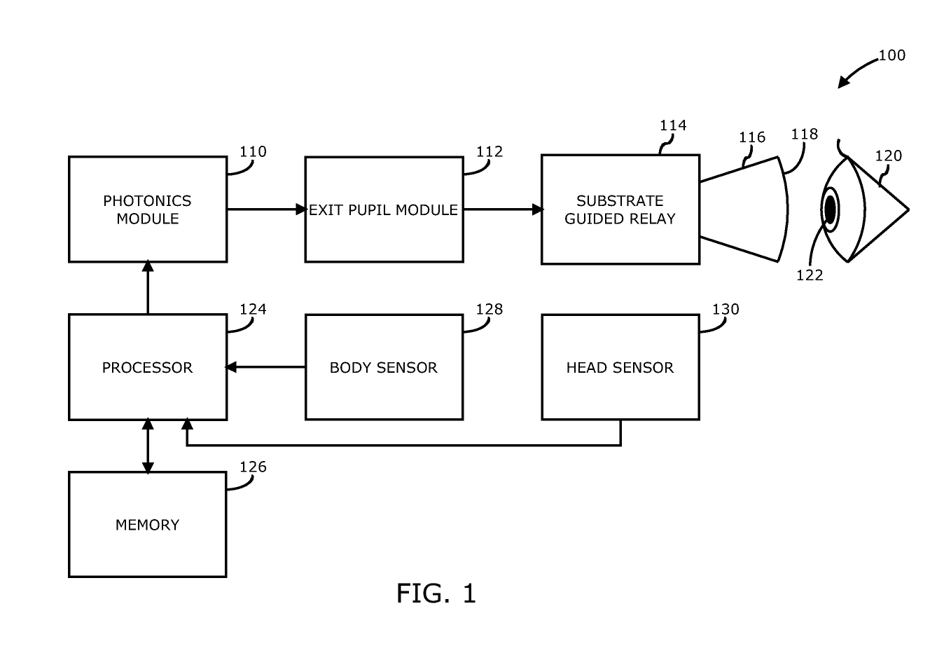

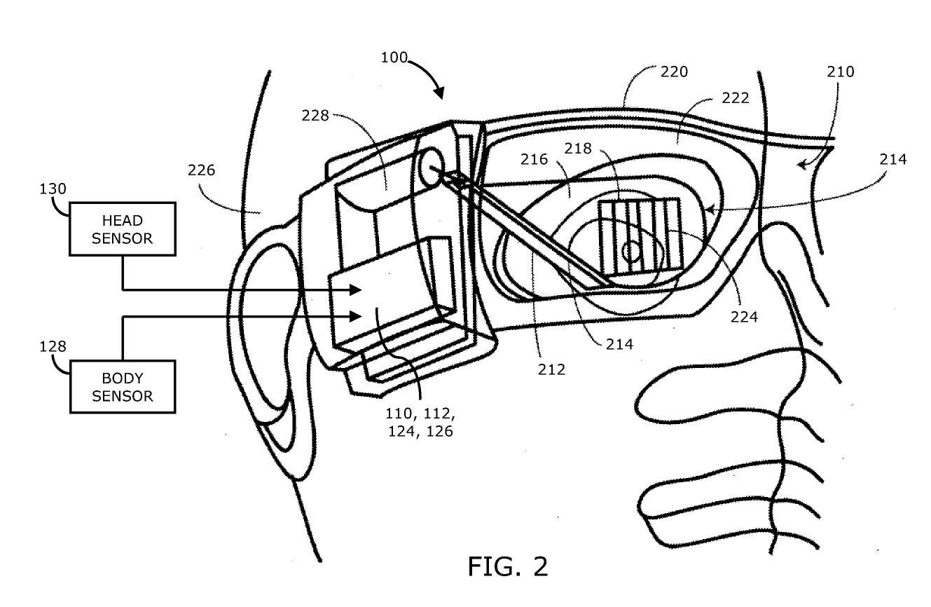

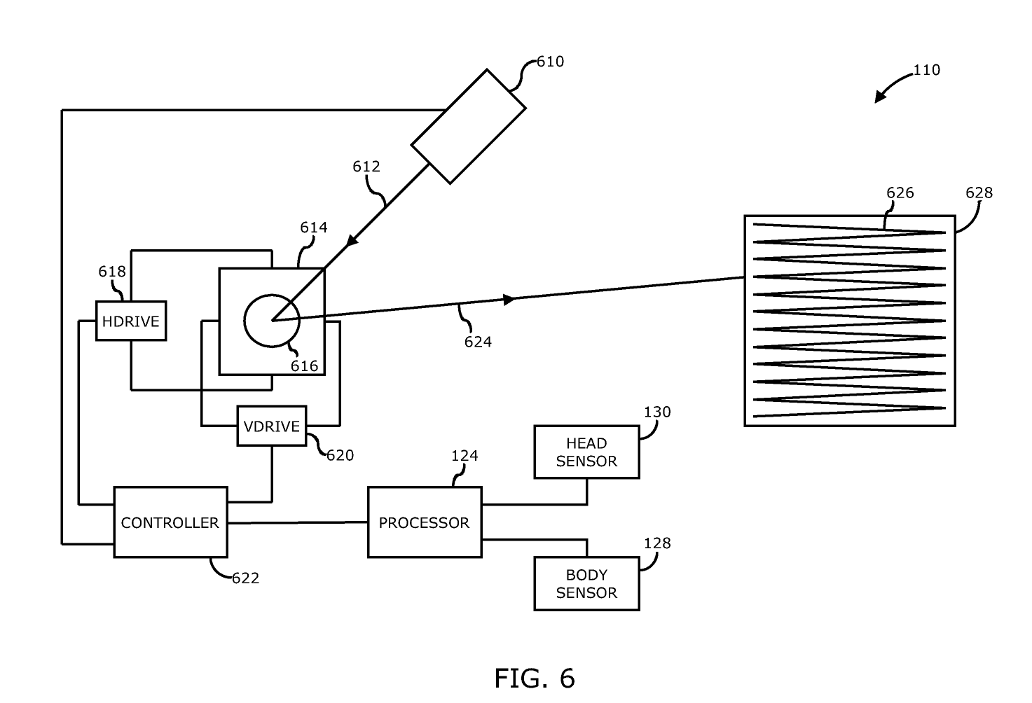

Referring now to FIG. 1, a block diagram of a display system that includes head and body sensors in accordance with one or more embodiments will be discussed. As shown in FIG. 1, display system 100 may comprise a head-up display (HUD) or the like that may be deployed in a head mount arrangement as shown in FIG. 2, below. Such a display system 100 may comprise a photonics module 110 or a projector that is capable of creating and/or projecting an image. An example of such a photonics module 110 comprising a scanned beam display is shown in and described with respect to FIG. 6, below. The output of photonics module 110 may be provided to an exit pupil module 112 that may be configured to expand the exit pupil of the output of photonics module 110, or alternatively may be configured to reduce the exit pupil of the output of photonics module 110 depending on the type of display technology of photonics module 110. For example, photonics module 110 may comprise a scanned beam display such as shown in FIG. 6 that scans a beam such as a laser beam in a raster pattern to generate a displayed image. Such a photonics module 110 may have a relatively small exit pupil that is smaller than a pupil 122 of the eye 120 of the user, in which case exit pupil module 112 may be configured to expand the exit pupil of the output of photonics module 110 to be larger than the pupil 122 of the user's eye 120 when the ultimate exit pupil 118 reaches the user's pupil 122. In such embodiments, exit pupil module 112 may comprise a microlens array (MLA) that operates to provide numerical aperture expansion of the beam in order to result in a desired expansion of the exit pupil. By expanding the exit pupil in such a manner, vignetting in the displayed image may be reduced or eliminated. Alternatively, photonics module 110 may comprise a digital light projector (DLP) or a liquid-crystal on silicon (LCOS) projector that generates a relatively larger sized exit pupil. In such embodiments, exit pupil module 112 may be configured to reduce the exit pupil of the image generated by photonics module 110 to be closer to, but still larger than, the pupil 122 of the user's eye 120. However, these are merely examples of how the exit pupil module 112 may alter the exit pupil of the image generated by photonics module 110, and the scope of the claimed subject matter is not limited in these respects.

In one or more embodiments, the image generated by photonics module 110 may be processed by a substrate guided relay (SGR) 114 which may operate to create one or more copies of the input light from photonics module 110 to create an output 116 that is more homogenized when the image reaches the user's eye 120. An example of such a substrate guided relay 114 and the operation thereof is shown in and described in U.S. Pat. No. 7,589,091 which is hereby incorporated herein by reference thereto in its entirety.

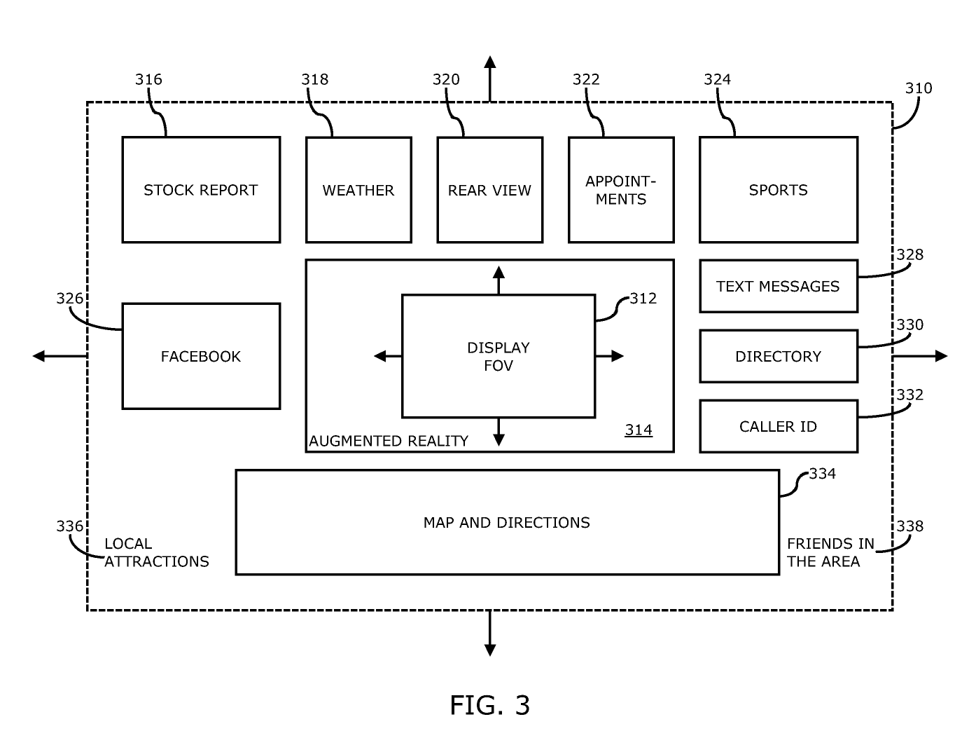

In one or more embodiments, display system 100 includes a processor 124 coupled to a body sensor 128 and a head sensor 130. The body sensor 128 is capable of detecting an orientation of the body of the user in order to control what information is displayed by display system 100 as will be discussed in further detail, below. Likewise, the head sensor 130 is capable of detecting an orientation of the head of the user in order to control what information is displayed by display system 100 as will be discussed in further detail, below. It should be noted that body sensor 128 may comprise one sensor or alternatively two or more sensors, and head sensor 130 may comprise one sensor or alternatively two or more sensors, and the scope of the claimed subject matter is not limited in this respect. In one or more embodiments, since body sensor 128 is capable of detecting a position of the user's body and head sensor 130 is capable of detecting a position of the user's head, processor 124 is capable of detecting the relative position of the user's head with respect to the position of the user's body. A memory 126 coupled to the processor 124 may contain video information to be displayed by display system 100. An overall display containing all or nearly all of the possible content in memory 126 to be displayed may be referred to as the meta-display as shown in further detail with respect to FIG. 3 below. The contents of the meta-display may be greater than the information displayed at any given instance in the field of view (FOV) of the display system 100. In one or more embodiments, the information that is displayed in the field of view of the display system 100 and/or what content is contained in the meta-display may be determined based at least in part on a detected orientation of the user's body by the body sensor 128, a detected orientation of the user's head by the head sensor 130, and/or a detected relative position of the user's head with respect to the user's body as detected by a combination of the body sensor 128 and the head sensor 130, although the scope of the claimed subject matter is not limited in these respects. As needed, display information stored in memory 126 may be updated and/or replaced in order to update the information displayed in the field of view of the display system 100 and/or to update the information stored in the meta-display, for example as the content to be displayed is updated or refreshed and/or based on the detected movement of the user's head or body, or combinations thereof, although the scope of the claimed subject matter is not limited in this respect. An example of a head mounted display system incorporating the display system 100 is shown in and described with respect to FIG. 2, below.

Referring now to FIG. 2, a diagram of a head mounted display system incorporating the display system 100 of FIG. 1 in accordance with one or more embodiments will be discussed. As shown in FIG. 2, in one embodiment of display system 100 may be tangibly embodied in head worn eyewear 210 comprising frame 220 and one or more lenses 222 in a glasses design. Eyewear 210 is worn on the head of a user 226 in a manner similar to how glasses are worn. In such an embodiment, eyewear 210 may include a module 228 in which photonics module 110, exit pupil module 112, processor 124, and/or memory 126 may be disposed, for example wherein module 228 is affixed to frame 220. Alternatively, module 228 may be disposed elsewhere for example in a user's pocket, backpack, shoulder strap, and so on, and coupled to eyewear 210 for example via an optical fiber or the like, and the scope of the claimed subject matter is not limited in this respect. In one or more embodiments, eyewear 210 may include substrate guided relay 114 comprising an input coupler 212 coupled to a slab guide 216 via interface 214, and an output coupler 218 comprising reflecting surfaces 224. Substrate guided relay 114 receives input light from photonics module 110 in module 228 via input coupler 212 and provides output light to the eye 120 of the user 226 via output coupler 218. As discussed herein, head sensor 130 provides an input to processor 124 in module 228 based on movement of the user's head, and body sensor 128 provides an input to processor 124 in module 228 based on movement of the user's body. Although FIG. 2 shows one particular embodiment of display system 100 comprising eyewear 210 for purposes of example, it should be noted that other types of display systems 100 may likewise be utilized, for example in a helmet, headgear or hat type of system, or in a vehicle mounted head up display (HUD) system, and the scope of the claimed subject matter is not limited in this respect. An example of a meta-display capable of being displayed by display system 100 based at least in part on input received from head sensor 130 and/or body sensor 128, or combinations thereof, is shown in and displayed with respect to FIG. 3, below.

Referring now to FIG. 3, a diagram of a meta-display capable of being displayed by the display system of FIG. 1 in accordance with one or more embodiments will be discussed. As shown in FIG. 3, meta-display 310 may comprise information to be displayed by display system 100. Display system 100 may have a field of view 312 which may be visible by the user 226. Field of view 312 may represent the portion of meta-display 310 instantaneously displayed by display system 100 and viewable by the user 226. The portion of meta-display 310 outside of field of view 312 may be referred to as augmented reality 314 in that such information may exist in memory 126 but is not viewable by the user until the field of view 312 is directed to the portion of meta-display 310 where such information is located. For example, meta-display 310 may include various types of regions in which various content may be assigned to be displayed in meta-display 310. Such regions may include, as some of multiple examples, stock report information 316 such as the current stock price for selected companies, weather information 318 such as the weather report for the user's current city, rear view information 320 such as display data from an optional rear mounted camera on eyewear 210, appointments or calendar information 322, and/or sports information 324 such as the latest sports scores for selected sports teams. In addition, meta-display 310 may include social network information 326 such as updates from Facebook or the like, text messages 328 sent to the user, directory information 328 such as a list of contacts and respective contact information for the user's employer, and/or caller identification (Caller ID) information 332 for recent calls to the user's phone or similar communication device. Further information may include map and directions region 334, and information generally located anywhere in meta-display without necessarily having a designated region of locus in meta-display 310, for example local attractions 336 pertaining to the user's current location or friends in the area 338 pertaining the friends of the user who may be nearby. It should be noted that these are merely examples of the types of information that is capable of being displayed in meta-display 310, and/or example locations and display regions, and the scope of the claimed subject matter is not limited in these respects.

In one or more embodiments, the head worn display such as eyewear 210 allows for the utilization of meta-display 310 as a larger virtual display that is larger than the amount of content that is capable of being displayed by display system 100 in field of view 312. As the head of the user 226 moves up or down or left or right, head sensor 130 is capable of detecting such movement and directing the field of view 312 upwardly, downwardly, leftwardly, or rightwardly, in response to the detected head movement to a corresponding portion of meta-display 310. When field of view 312 is thus directed to a new location in meta-display 310 accordingly, the content at the corresponding location that was previously not in view then comes into view within field of view 312 so that display system 100 displays the new content wherein the user 226 may then see that content within the field of view 312. Display system 100 is capable of detecting the movement of the user's head with respect to the user's body, for example using the user's shoulders as a reference, so that meta-display 310 may be held in place by the user's non-moving body based on reference information received from body sensor 128. As a result, movement of the user's head based on reference information from head sensor 130 may be detected relative to the user's body.

In one or more embodiments, as an example meta-display 310 may comprise an approximately 180 degree horizontal by an approximately 150 degree vertical field of view that is accessible by movement of the user's head to move the field of view 312 of the display system 100 to a desired virtual location in meta-display 310 to view the desired contents at the corresponding virtual location in meta-display 310. It should be noted that meta-display 310 may comprise any selected range of horizontal and vertical field of view, either planar, curved planar, and/or spherical in layout, and in some embodiments may comprise a full 360 degrees of view in both the horizontal and vertical directions although the scope of the claimed subject matter is not limited in these respects. In some embodiments, field of view 312 may comprise a field of view that is more limited than the virtual field of view of meta-display 310 and may comprise as an example an approximately 40 degree field of view both horizontally and vertically, or alternatively may comprise other aspect ratios such as 16 by 10, 16 by 9 and so on, and the scope of the claimed subject matter is not limited in this respect.

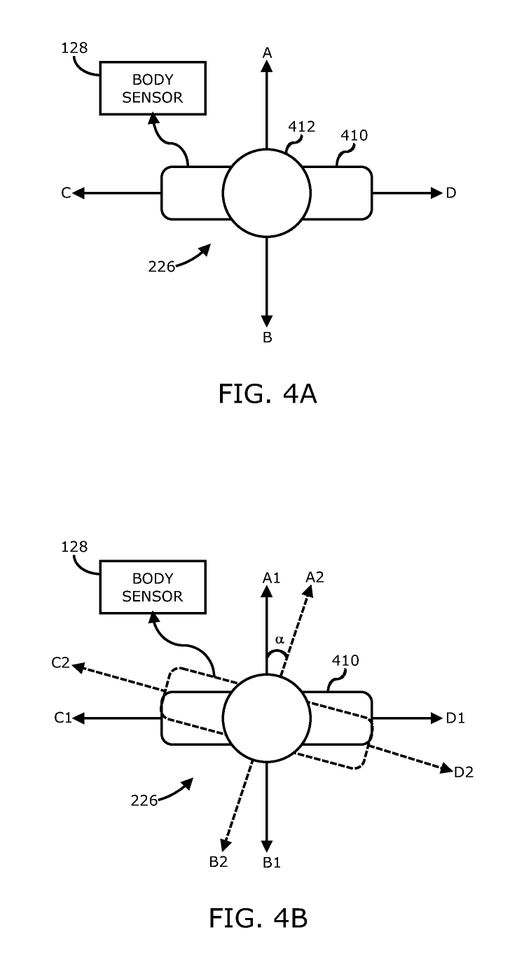

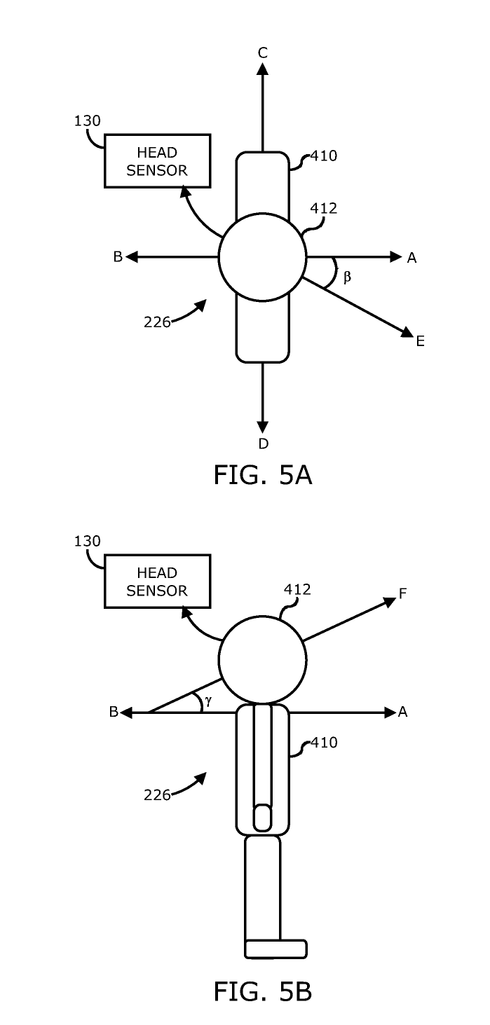

Since the meta-display 310 may be fixed to the user's body as a reference, the user simply moves his head with respect to his body to direct field of view 312 to a desired location in meta-display 310. Display system 100 tracks the angle of the user's head with respect to the user's body to determine the amount of movement of the user's head and then determines the amount of displacement of the field of view 312 with respect to the virtual meta-display 310 to the corresponding new location. The information at the corresponding new position in meta-display 310 is obtained from memory 126 and caused to be displayed within field of view 312. This results in a virtual reality system for access to the content in meta-display 310 based on the relative movement of the user's head with respect to the user's body. When the user moves his body to a new orientation the amount of movement of the user's body is detected by body sensor 128 so that the entirety of virtual meta-display 310 is correspondingly moved to a new location in virtual space. For example, if the user turns his body 30 degrees to the right, the contents of meta-display 310 are likewise moved 30 degrees to the right so that the meta-display 310 is always referenced directly in front of the user's body. Other arrangements of the orientation of the meta-display 310 with respect to the user's body may likewise be provided in alternative embodiments, for example by relocating the meta-display 310 only upon the user moving his body by a threshold amount such as in 15 degree increments and otherwise maintaining the meta-display 310 in a fixed location, and the scope of the claimed subject matter is not limited in this respect. Examples of how movement of the user's body and head may be detected are shown in and described with respect to FIGS. 4A and 4B and in FIGS. 5A and 5B, below.

Referring now to FIGS. 4A and 4B, diagrams of how a body sensor of the display system of FIG. 1 is capable of detecting a position of the body of a user in accordance with one or more embodiments will be discussed. The view in FIG. 4A shows the user 226 from a top view showing the user's head 412 and body 410. As shown in FIG. 4A, a body sensor 128 may be utilized to determine an orientation of a user 226 of display system 100. In operation, body sensor 128 may obtain data pertaining to an orientation of the body 410 of the user 226. In one embodiment, two orthogonal axes may define a frame of reference for the user's body 410. For example, axis AB may define a first direction, and axis CD may define a second direction wherein the user 226 is facing forward in direction A, and direction B may be directly behind the user 226. Direction C may define the left side of the user 226, and direction D may define the right side of the user 226. In an alternative embodiment, a third axis may define a third direction of movement of the user 226 for up and down movements, although the scope of the claimed subject matter is not limited in this respect. Although FIG. 4A shows linear orthogonal axes to define a frame of reference of the body of the user in one, two, or three directions, it is noted that other types of coordinate systems may likewise be utilized, for example polar and/or spherical coordinates, and the scope of the claimed subject matter is not limited in this respect.

FIG. 4B shows the rotation of the body 410 of the user 226 from a first position defined by A1B1 and C1D1 to a second position A2B2 and C2D2 by an angle, alpha (α). Body sensor 128 is capable of detecting such movement of the body 410 of the user 226. In some embodiments, processor 124 may shift the virtual position of meta-display 310 proportional to the movement of the user's body 410, for example so that the meta-display 310 remains in front of the user 226 in direction A. In this arrangement, the center of meta-display 310 may be generally aligned with direction A1 at the first position, and meta-display 310 may be moved so that the center of meta-display is generally aligned with direction A2 in the second position. Similarly, as the user moves to the left in direction C1 or to the right in direction D1, the processor 124 may move meta-display 310 to the left or to the right proportional to the movement of the user's body 410 as detected by body sensor 128. Furthermore, as the user 226 moves forward in direction A1 or backwards in direction B1, processor 124 may cause meta-display 310 to grow or shrink in size proportional to the movement of the user's body 410. In general, when the user's body 226 moves, the processor 124 is capable of causing the meta-display 310 to move and/or change in response to the movement of the user's body 410. Thus, the user 226 may move about in a virtual space defined by meta-display 310 such that the contents and/or location of meta-display 310 may be altered, updated, and/or repositioned according to the movements of the user's body 410 as detected by body sensor 128. Detection of the user's head 412 may be made by head sensor 130 as shown in and described with respect to FIG. 5A and FIG. 5B.

Referring now to FIGS. 5A and 5B, diagrams of how a head sensor is capable of detecting a position of the head of a user with respect to a position of the body of the user in accordance with one or more embodiments will be discussed. FIG. 5A shows the user 226 from a top view, and FIG. 5B shows the user 226 from a side view. In FIG. 5A, the head sensor 130 is capable of detecting movement of the head 412. In some embodiments, head sensor 130 detects absolute movements of the head 412 by itself, and in some embodiments head sensor 130 detects movement of the head 412 with respect to the user's body 410. In general, the user's head moves rotationally in the horizontal direction to the left or right of the user 226, and also moves rotationally in the vertical direction upwards or downwards. As shown in FIG. 5A, the user's head 412 has been rotated an angle, beta (β), to the right away from direction A and toward direction D so that the user's gaze points in direction E. Head sensor 130 detects this movement of the user's head 412 and moves the field of view 312 of the display system 100 a proportional amount within meta-display 310 to the right. Likewise, as shown in FIG. 5B, the user's head 412 has been rotated upwards by an angle, gamma (γ), with respect to the AB line so that the user's gaze points in direction F. Head sensor 130 detects this movement of the user's head 412 and moves the field of view 312 of the display system 100 a proportional amount within meta-display 310 upwards. Thus, by detecting the movement of the user's head 412 via head sensor 130, processor 124 of display system 100 may cause the appropriate portion of meta-display 310 to be displayed within field of view 312 so that the user 226 may view the desired content of meta-display 310 that the user 226 controls by movement of his head 412.

Thus, as shown herein, a relatively smaller physical field of view 312, for example approximately 40 degrees, of display system 100 may be used to view a relatively lager virtual meta-display 310, for example 180 by 150 degrees, by detecting movement of the user's head 412 and/or the user's body 410, independently and/or together with respect to one another, for example by detecting an angle of movement of the user's head 412 with respect to the user's body 410 via head sensor 130 and body sensor 128. The sensors my comprise any various types of measurement systems that may be utilized to track such movements, wherein the measurement systems may comprise, for example, gyros or gyroscopes, accelerometers, digital compasses, magnetometers, global positioning system (GPS) devices or differential GPS devices, differential compasses, and so on, or combinations thereof.

In one or more embodiments, some display panels or regions in meta-display 310 may have content that changes as the user's body changes but otherwise remain fixed in position with respect to motion of the user's head 412, for example augmented reality region 314, rear view region 320, or map and directions region 334. In one or more alternative embodiments, some display panels or regions in meta-display may have content that is fixed in location in meta-display 310 independent of the position or movement of the user's body 410. In yet other embodiments, some display panels or regions in meta-display 310 may have content that changes or moves in response to both movement of the user's head 412 and in response to movement of the user's body 410, for example the local attractions region 336 or the friends in the area region 338.

In some embodiments, two or more regions of display panels in meta-display 310 may at least partially overlap. For example, the local attractions region 336 may be shown anywhere in the meta-display 310, for example in an area that has no other panels, or at least partially overlapping with map and directions region 334. The user 226 may set up his or her preferences for such display behaviors as discussed herein by programming processor 124 and storing the preferences in memory 126. Furthermore, software running in processor 124 and/or preferences stored in memory 126 may dictate how conflicts between different regions of meta-display 310 are handled. For example, a movable region may eventually contact with a fixed region, in which case the moveable region may stop at the edge of the fixed region, may overlap the fixed region, or both regions may become moveable regions that move in tandem when their borders contact one another.

In one or more embodiments, panes or regions of meta-display 310 may be reconfigured, resized, relocated, enabled or disabled, and so on. Audio alerts for information may be linked to the viewing position of the field of view 312, or may be independent of the field of view 312. For example, an alert may sound when the user 226 receives a text message displayed in text message region 328 upon the user 226 causing the text message region 328 to come within the field of view 312, or the user 226 may hear an audible caller ID message regardless of whether or not caller ID region 332 is visible within field of view 312. An audio weather alert may be played only when the user 226 accesses the weather window 318 by moving the field of view 312 to weather window 318. At the user's option, audio feeds may be paused when the field of view 312 is moved away from the corresponding pane or region in meta-display 310, or alternatively audio fees may continue to play even when the field of view 312 is moved away from the corresponding pane or region in meta-display 310. In some embodiments, the user 226 may drag a pane or region to any desired location in meta-display 310, for example when the user 226 is riding on an airplane, the user 226 may drag a movie pane to the center of the field of view 312 and resize the movie pane to a desired size for comfortable viewing. In some embodiments, the user may turn on or off some or all of the panes or regions of meta-display 310 based on a command or series of commands. It should be noted these are merely examples of how different portions and regions of meta-display may be moved or fixed in place in response to movement of the user's head 412 and/or body 410, and/or how the behavior of the panes or regions of meta-display 310 may be configure and controlled by the user 226, and the scope of the claimed subject matter is not limited in these respects.

In one or more embodiments, the content in the meta-display 310 may be accessed and/or controlled via various movements or combinations of movements of the user's body via body sensor 128 and/or the user's head via head sensor 130. For example, a fixed cursor may be provided in meta-display 310 to manipulate or select the content in the meta-display 310 wherein the cursor may be moved via movement of the user's head with respect to the user's body as one of several examples. In one example, the cursor may be fixed in the display field of view 312, for example at its center, and may be moved to a desired location within meta-display 310 when the user moves his head to move the field of view 312 to a desired location in meta-display 310. Alternatively, the cursor may be moveable by an external mouse control, for example via a mouse sensor connected to the user's arm, wrist, or hand, or held in the user's hand, among several examples. Any sensor that is capable of detecting the user's hand, wrist, arm, or fingers, or other body parts, including movements thereof, as control inputs may be referred to as a manual sensor. In some embodiments, the cursor may be moved and controlled by an eye or gaze tracking systems or sensors having optical tracking sensors that may be mounted, for example, on frame 220. In general, an eye or gaze system may be referred to as an optical tracking system and may comprise a camera or the like to detect a user's eye or gaze as a control input. Furthermore, a manual sensor may comprise an optical tracking system or optical sensor such as a camera or the like to detect a user's hand, wrist, arm or fingers, or other body parts, including movements thereof, as control inputs, and the scope of the claimed subject matter is not limited in these respects. Such an external mouse, manual sensor, optical sensor, and/or eye/gaze optical tracking system may be coupled to processor 124 via a wired or wireless connection and may include gyroscopic and/or accelerometer sensors, cameras, or optical tracking sensors to detect movement of the external mouse or body part movements to allow the user to move the cursor to desired locations within the meta-display 310 to select, access, or manipulate the content of meta-display 310.

In some embodiments, specific movements may be utilized to implement various mouse movements and controls. For example, movement of the field of view 312 and/or meta-display 310 may be controlled in proportion to the velocity of movement of the user's head and/or body. For example, higher velocity movements of the user's head may result in higher velocity movements of the FOV 312 with respect to meta-display 310 and/or the contents of meta-display may move with respect to FOV 312 proportional to the velocity of movement of the user's head such as in a variable speed scrolling movement. In some embodiments, the speed of scrolling of the contents of meta-display 310 may be proportional to the position of the user's head with respect to the user's body wherein a larger displacement of the user's head with respect to the user's body results in faster scrolling, and a smaller displacement results in slower scrolling. Such an arrangement may allow for a vertical and/or horizontal scrolling of the meta-display 310 such that the content of meta-display 310 may be continuously scrolled for 360 degrees of content or more. In some further embodiments, specific movements may result in specific mouse control inputs. For example, a sharp nod of the user's head may be used for a mouse click, a sharp chin up movement may result in a go back command, and so on, and the scope of the claimed subject matter is not limited in these respects.

In some embodiments, combinations of inputs from the sensors may be utilized to control the movement of the display field of view (FOV) 312 with respect to the meta-display 310. For example, as the user's head turns to the right as detected by head sensor 130 and/or body sensor 128, FOV 312 scrolls to the right within meta-display 310. If the user's eyes are also looking to the right as detected by the eye tracking sensor, FOV 312 may scroll to the right within meta-display at an even faster rate. Alternatively, in some embodiments, opposite movements of FOV 312 with respect to meta-display 310 may result depending on setting or preferences. For example, the user moving his head to the right may cause meta-display 310 to move to the right with respect to FOV 312, and so on. In another embodiment, the rate of scrolling may be based at least in part on the angle of the head with respect the body, and/or the angle of the eyes with respect to the user's head, wherein a faster rate may be reached at or above an angle threshold in a discrete manner, or may be proportional to the angle in a continuously variable angle and scroll rate value. Vice-versa, smaller angles may result in slower scroll speeds. Furthermore, the user's hand or hands may be used to control the scrolling of the FOV 312 with respect to meta-display 310, for example based on a mouse sensor held in the user's hand or attached to the user's hand, finger, arm or wrist. In such embodiments, the user may hold up his hand toward the right to move the FOV 312 to the right within meta-display 310, and may hold up is hand toward the left to move the FOV 312 to the left within meta-display 310. Furthermore, other gestures may result in desired display movements such as flicks to the right or to the left and so on. In yet additional embodiments, FOV 312 may include a cursor permanently, or semi-permanently fixed wherein the user may turn on or off the cursor or may move the cursor to a selected position in the display, in the center of the FOV 312 or some other position. The user may move his or her head to select objects of interest in meta-display 310. The user may then select the object that the cursor is pointing to by dwelling on the object for a predetermined period of time, or otherwise by some click selection. Such movement of the cursor may be achieved via movement of the user's head or eyes, or combinations thereof, although the scope of the claimed subject matter is not limited in these respects

Referring now to FIG. 6, a diagram of a photonics of module comprising a scanned beam display of the display system of FIG. 1 in accordance with one or more embodiments will be discussed. Although FIG. 6 illustrates one type of a scanned beam display system for purposes of discussion, for example a microelectromechanical system (MEMS) based display, it should be noted that other types of scanning displays including those that use two uniaxial scanners, rotating polygon scanners, or galvonometric scanners as well as systems that use the combination of a one-dimensional spatial light modulator with a single axis scanner as some of many examples, may also utilize the claimed subject matter, and the scope of the claimed subject matter is not limited in this respect. Furthermore, projectors that are not scanned beam projectors but rather have two-dimensional modulators that introduce the image information in either the image plane or Fourier plane and which introduce color information time sequentially or using a filter mask on the modulator as some of many examples, may also utilize the claimed subject matter and the scope of the claimed subject matter is not limited in this respect. Furthermore, photonics module 110 may be adapted to project a three-dimensional image as desired using three-dimensional imaging techniques. Details of operation of scanned beam display to embody photonics module 110 are discussed, below.

As shown in FIG. 6, photonics module 110 comprises a light source 610, which may be a laser light source such as a laser or the like, capable of emitting a beam 612 which may comprise a laser beam. In some embodiments, light source 610 may comprise two or more light sources, such as in a color system having red, green, and blue light sources, wherein the beams from the light sources may be combined into a single beam. In one or more embodiments, light source 610 may include a first full color light source such as a red, green, and blue light source, and in addition may include a fourth light source to emit an invisible beam such as an ultraviolet beam or an infrared beam. The beam 612 is incident on a scanning platform 614 which may comprise a microelectromechanical system (MEMS) based scanner or the like in one or more embodiments, and reflects off of scanning mirror 616 to generate a controlled output beam 624. In one or more alternative embodiments, scanning platform 614 may comprise a diffractive optic grating, a moving optic grating, a light valve, a rotating mirror, a spinning silicon device, a digital light projector device, a flying spot projector, or a liquid-crystal on silicon device, or other similar scanning or modulating devices. A horizontal drive circuit 618 and/or a vertical drive circuit 620 modulate the direction in which scanning mirror 616 is deflected to cause output beam 624 to generate a raster scan 626, thereby creating a displayed image, for example on a display screen and/or image plane 628. A display controller 622 controls horizontal drive circuit 618 and vertical drive circuit 620 by converting pixel information of the displayed image into laser modulation synchronous to the scanning platform 614 to write the image information as a displayed image based upon the position of the output beam 624 in raster pattern 626 and the corresponding intensity and/or color information at the corresponding pixel in the image. Display controller 622 may also control other various functions of photonics module 110. Processor 124 as shown in FIG. 1 may receive position and/or movement information from head sensor 130 and/or body sensor 128 and couples to controller 622 to control the image displayed by photonics module 110 in response to the inputs received from the head sensor 130 and body sensor 128 as discussed herein.

In one or more embodiments, a horizontal axis may refer to the horizontal direction of raster scan 626 and the vertical axis may refer to the vertical direction of raster scan 626. Scanning mirror 616 may sweep the output beam 624 horizontally at a relatively higher frequency and also vertically at a relatively lower frequency. The result is a scanned trajectory of laser beam 624 to result in raster scan 626. The fast and slow axes may also be interchanged such that the fast scan is in the vertical direction and the slow scan is in the horizontal direction. However, the scope of the claimed subject matter is not limited in these respects.

In one or more particular embodiments, the photonics module 110 as shown in and described with respect to FIG. 6 may comprise a pico-projector developed by Microvision Inc., of Redmond, Wash., USA, referred to as PicoP™. In such embodiments, light source 610 of such a pico-projector may comprise one red, one green, one blue, and one invisible wavelength laser, with a lens near the output of the respective lasers that collects the light from the laser and provides a very low numerical aperture (NA) beam at the output. The light from the lasers may then be combined with dichroic elements into a single white beam 612. Using a beam splitter and/or basic fold-mirror optics, the combined beam 612 may be relayed onto biaxial MEMS scanning mirror 616 disposed on scanning platform 614 that scans the output beam 624 in a raster pattern 626. Modulating the lasers synchronously with the position of the scanned output beam 624 may create the projected image. In one or more embodiments the photonics module 110 or engine, may be disposed in a single module known as an Integrated Photonics Module (IPM), which in some embodiments may be 7 millimeters (mm) in height and less than 5 cubic centimeters (cc) in total volume, although the scope of the claimed subject matter is not limited in these respects.

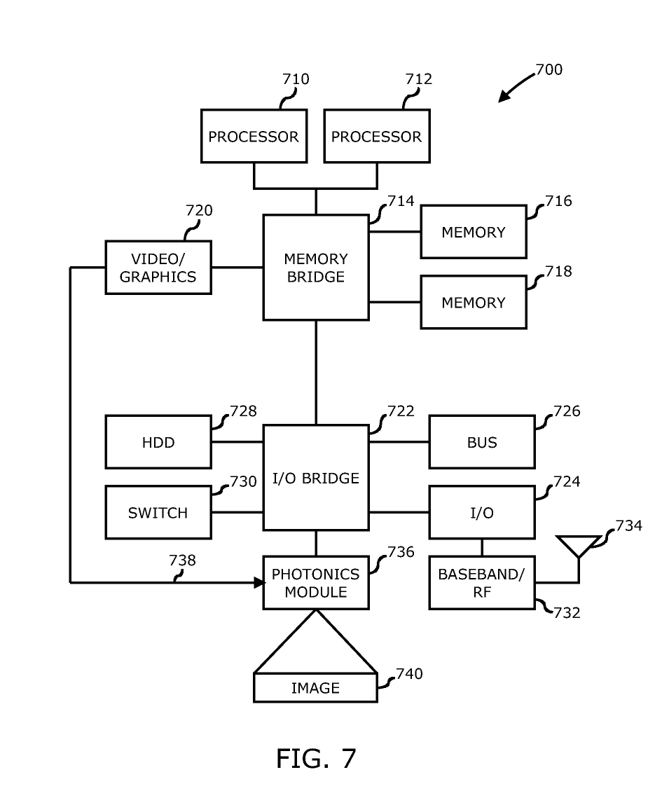

Referring now to FIG. 7, a diagram of an information handling system capable of operating with the display system of FIG. 1 in accordance with one or more embodiments will be discussed. Information handling system 700 of FIG. 7 may tangibly embody display system 100 as shown in and described with respect to FIG. 1. Although information handling system 700 represents one example of several types of computing platforms, including cell phones, personal digital assistants (PDAs), netbooks, notebooks, internet browsing devices, tablets, and so on, information handling system 700 may include more or fewer elements and/or different arrangements of the elements than shown in FIG. 7, and the scope of the claimed subject matter is not limited in these respects.

Information handling system 700 may comprise one or more processors such as processor 710 and/or processor 712, which may comprise one or more processing cores. One or more of processor 710 and/or processor 712 may couple to one or more memories 716 and/or 718 via memory bridge 714, which may be disposed external to processors 710 and/or 712, or alternatively at least partially disposed within one or more of processors 710 and/or 712. Memory 716 and/or memory 718 may comprise various types of semiconductor based memory, for example volatile type memory and/or non-volatile type memory. Memory bridge 714 may couple to a video/graphics system 720 to drive a display device, which may comprise projector 736, coupled to information handling system 700. Projector 736 may comprise photonics module 110 of FIG. 1 and/or FIG. 6. In one or more embodiments, video/graphics system 720 may couple to one or more of processors 710 and/or 712 and may be disposed on the same core as the processor 710 and/or 712, although the scope of the claimed subject matter is not limited in this respect.

Information handling system 700 may further comprise input/output (I/O) bridge 722 to couple to various types of I/O systems. I/O system 724 may comprise, for example, a universal serial bus (USB) type system, an IEEE 1394 type system, or the like, to couple one or more peripheral devices to information handling system 700. Bus system 726 may comprise one or more bus systems such as a peripheral component interconnect (PCI) express type bus or the like, to connect one or more peripheral devices to information handling system 700. A hard disk drive (HDD) controller system 728 may couple one or more hard disk drives or the like to information handling system, for example Serial Advanced Technology Attachment (Serial ATA) type drives or the like, or alternatively a semiconductor based drive comprising flash memory, phase change, and/or chalcogenide type memory or the like. Switch 730 may be utilized to couple one or more switched devices to I/O bridge 722, for example Gigabit Ethernet type devices or the like. Furthermore, as shown in FIG. 7, information handling system 700 may include a baseband and radio-frequency (RF) block 732 comprising a base band processor and/or RF circuits and devices for wireless communication with other wireless communication devices and/or via wireless networks via antenna 734, although the scope of the claimed subject matter is not limited in these respects.

In one or more embodiments, information handling system 700 may include a projector 736 that may correspond to photonics module 110 and/or display system 100 of FIG. 1, and which may include any one or more or all of the components of photonics module 110 such as controller 622, horizontal drive circuit 618, vertical drive circuit 620, and/or laser source 610. In one or more embodiments, projector 736 may be controlled by one or more of processors 710 and/or 712 to implement some or all of the functions of processor 124 of FIG. 1 and/or controller 622 of FIG. 6. In one or more embodiments, projector 736 may comprise a MEMS based scanned laser display for displaying an image 640 projected by projector 636. In one or more embodiments, a display system 100 of FIG. 1 may comprise video/graphics block 720 having a video controller to provide video information 738 to projector 736 to display an image 640. In one or more embodiments, projector 636 may be capable of generating a meta-display 310 and field of view 312 based at least in part on the detected movement of the user's body 410 and head 412 as discussed herein. However, these are merely example implementations for projector 736 within information handling system 700, and the scope of the claimed subject matter is not limited in these respects.

Although the claimed subject matter has been described with a certain degree of particularity, it should be recognized that elements thereof may be altered by persons skilled in the art without departing from the spirit and/or scope of claimed subject matter. It is believed that the subject matter pertaining to a head mounted meta-display system and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. A method, comprising:
storing a display having a first field of view in a memory;
displaying at least a portion of the first field of view in a second field of view, the first field of view being larger than the second field of view;
detecting a position of a user's body with a body sensor; and
detecting a position of the user's head with a head sensor;
wherein the portion of the first field of view displayed in the second field of view is based on a position of the user's head with respect to the user's body.

2. A method as claimed in claim 1, wherein said detecting a position of the user's head comprises detecting a movement of the user's head from a first position to a second position, the method further comprising moving the second field of view in response to the movement of the user's head to display another portion of the first field of view in the second field of view corresponding to the second position.

3. A method as claimed in claim 1, wherein said detecting a position of the user's head comprises detecting a movement of the user's head, the method further comprising moving the second field of view proportional to the movement of the user's head to display another portion of the first field of view in the second field at a new portion of the first field of view.

4. A method as claimed in claim 1, wherein the display in the first field of view comprises at least some content that is located outside of the second field of view and is not displayed in the second field of view until the user moves the user's head toward the content, wherein the content is at least partially displayed in the second field of view in response to the user moving the user's head toward the content.

5. A method as claimed in claim 1, wherein said detecting a position of the user's body comprises detecting a movement of the user's body, the method further comprising moving the first field of view proportional to the movement of the user's body to relocate the first field of view to a new location.

6. A method as claimed in claim 1, further comprising controlling a cursor in the first field of view via movement of the user's head, the user's body, a mouse, or an eye or gaze tracking system, or combinations thereof, to access, select, or manipulate, content in the second field of view.

7. A method as claimed in claim 1, wherein the first field of view comprises one or more regions in which content is displayed, wherein the second field of view is directed to a selected region to display the content in the second field of view in response to detecting an appropriate movement of the user's head with respect to the user's body via said detecting a position of the user's body and said detecting a position of the user's head.

8. A method as claimed in claim 1, further comprising detecting a position of the user's eyes with an eye tracking sensor, wherein the portion of the first field of view displayed in the second field of view is based at least in part on a position of the user's eye's.

9. A method as claimed in claim 1, further comprising detecting a position of the user's hand, wrist or arm with a manual sensor, wherein the portion of the first field of view displayed in the second field of view is based at least in part on a position of the user's hand, wrist or arm.

10. A method as claimed in claim 1, further comprising detecting a position of the user's eyes with an eye tracking sensor or detecting a position of the user's hand, wrist or arm with a manual sensor, or combinations thereof, wherein the portion of the first field of view displayed in the second field of view is based at least in part on a position of the user's eyes or the user's hand, wrist or arm, or combinations thereof.

11. A method as claimed in claim 1, further comprising detecting movements of the user's eyes with an eye tracking system, wherein the portion of the first field of view displayed in the second field of view is based on a position of the user's head with respect to the user's body and further controlled by the detected movements of the user's eyes.

12. A method as claimed in claim 1, further comprising detecting a gesture of the user's hand, wrist or arm with a manual sensor, wherein the portion of the first field of view displayed in the second field of view is based on a position of the user's head with respect to the user's body and further controlled by the detected gestures of the user's hand, wrist or arm.

13. A method as claimed in claim 1, further comprising detecting movements of the user's eyes with an eye tracking system or detecting a gesture of the user's hand, wrist or arm with a manual sensor, or combinations thereof, wherein the portion of the first field of view displayed in the second field of view is based on a position of the user's head with respect to the user's body and further controlled by the detected movements of the user's eyes or by the detected gestures of the user's hand, wrist or arm, or combinations thereof.

14. A display system, comprising:
a memory to store a display having a first field of view;
a photonics module to display a portion of the first field of view in a second field of view, the first field of view being larger than the second field of view;
a body sensor to detect a position of a user's body; and
a head sensor to detect a position of the user's head;
wherein the portion of the first field of view displayed in the second field of view is based on a position of the user's head with respect to the user's body.

15. A display system as claimed in claim 14, further comprising a processor coupled to the body sensor and to the head sensor to detect a movement of the user's head from a first position to a second position, and to move the second field of view in response to the movement of the user's head to display another portion of the first field of view in the second field of view corresponding to the second position.

16. A display system as claimed in claim 14, further comprising a processor coupled to the body sensor and to the head sensor to detect a movement of the user's head, and to move the second field of view proportional to the movement of the user's head to display another portion of the first field of view in the second field at a new portion of the first field of view.

17. A display system as claimed in claim 14, wherein the display in the first field of view comprises at least some content that is located outside of the second field of view and that is not displayed in the second field of view until the user moves the user's head toward the content, wherein the content is at least partially displayed in the second field of view in response to the user moving the user's head toward the content.

18. A display system as claimed in claim 14, further comprising a processor coupled to the body sensor and to the head sensor to detect a movement of the user's body, and to move the first field of view proportional to the movement of the user's body to relocate the first field of view to a new location.

19. A display system as claimed in claim 14, further comprising a processor coupled to the body sensor, the head sensor, a mouse sensor, or eye or gaze tracking system, to control a cursor in the first field of view via movement of the user's head, the user's body, or the mouse sensor, or combinations thereof, to access, select, or manipulate, content in the second field of view.

20. A display system as claimed in claim 14, further comprising a processor coupled to the body sensor and to the head sensor, wherein the first field of view comprises one or more regions in which content is displayed, wherein the second field of view is directed to a selected region to display the content in the second field of view in response to detecting an appropriate movement of the user's head with respect to the user's body via said body sensor and said head sensor.

21. An information handling system, comprising:
a processor coupled to a memory, wherein a display having a first field of view is stored in the memory;
a display system coupled to the processor, the display system comprising a photonics module to display a portion of the first field of view in a second field of view, the first field of view being larger than the second field of view;
a body sensor to detect a position of a user's body; and
a head sensor to detect a position of the user's head;
wherein the portion of the first field of view displayed in the second field of view is based on a position of the user's head with respect to the user's body.

22. An information handling system as claimed in claim 21, wherein the display system comprises a head mounted device and wherein the head sensor is disposed in the head mounted device.

23. An information handling system as claimed in claim 21, wherein the display system comprises eyewear, a helmet, or headgear, or combinations thereof.

24. An information handling system as claimed in claim 21, wherein the processor and the memory comprise a body mounted device and wherein the body sensor is disposed in the body mounted device.

25. An information handling system as claimed in claim 21, wherein the display system comprises an exit pupil module or a substrate guided relay, or combinations thereof.

26. An information handling system as claimed in claim 21, further comprising a mouse sensor, wherein the body sensor, the head sensor, or the mouse sensor, or an eye or gaze tracking system, or combinations thereof, comprise one or more gyros, gyroscopes, accelerometers, digital compasses, magnetometers, global positioning system devices, differential global positioning system devices, differential compasses, or optical tracking system, or combinations thereof.
